(19) United States
(12) Patent Application Publication
(10) Pub. No.: US 2018/0137568 A1
(43) Pub. Date: May 17, 2018

(54) TECHNIQUES FOR AUTOMATED PRICE INDICATIONS

(71) Applicant: STATE STREET CORPORATION, Boston, MA (US)

(72) Inventors: Stephen R. Schonberg, Alpine, NJ (US); Uri Lerman, Glen Rock, NJ (US); Jonathan Gregorio, Brooklyn, NY (US)

(21) Appl. No.: 15/669,518

(22) Filed: Aug. 4, 2017

Related U.S. Application Data
(60) Provisional application No. 62/371,357, filed on Aug. 5, 2016.

(51) Int. Cl. G06Q 40/04; G06F 3/048; G06Q 40/06; H04L 29/08

(52) U.S. Cl. CPC G06Q 40/04; H04L 67/12; G06Q 40/06; G06F 3/048

(57) ABSTRACT

Various embodiments are generally directed to techniques for automated price indication on a trading platform. Techniques described herein may provide an automated price indication method and system that provides a graphical user interface with one or more user interface items representing an indication of price at various liquidity levels based upon a received size of an order. A communication module of a trading platform may periodically receive price information. A price module may automatically determine a top of book (TOB) price for a particular asset based upon the received price information. A processor may configure the display of the determined TOB price in a graphical user interface (GUI) of the trading platform. Order information may be received by the processor with respect to the particular asset. The price module may automatically determine a first near-TOB price and a second near-TOB price based upon the received order information and the periodically received pricing information. The processor may automatically configure the display of a first indication of the first near-TOB price in the GUI of the trading platform. The processor may configure the display of a second indication of the second near-TOB price in the GUI of the trading platform. The processor may receive an order indicating a trade at either the first near-TOB price or the second near-TOB price.

### RELATED APPLICATIONS

This application claims the benefit of priority under 35 U.S.C. § 119(e) to U.S. Provisional Application No. 62/371,357, entitled “TECHNIQUES FOR AUTOMATED PRICE INDICATIONS”, filed Aug. 5, 2016, which is hereby incorporated by reference in its entirety.

### BACKGROUND

Asset trading platforms may allow traders to buy and sell positions in various asset classes, such as foreign exchange (FOREX) or securities, for example. Effectively trading on a trading platform requires information on the current bids and offers for a particular asset. Commonly, the top of book (TOB) refers to the best bid and the best offer for a particular asset, sometimes referred to as the touch price. In some situations, however, traders may wish to trade more of a particular asset than is available at TOB. In an example, a particular TOB price may be available for 1 M of an asset, while a trader may desire to trade 5 M of the asset. In this situation, the price for the entire 5 M trade may be somewhere through TOB (e.g., below the best bid, above the best offer). The trader may be unsure of the most effective trading price for the 5 M trade, as the price lies somewhere beyond TOB. Thus, improved techniques for automated price indicators are needed to enable effective trading at larger order sizes than the TOB may provide.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Techniques described herein may provide an automated methods and systems that provides a graphical user interface with one or more user interface items representing price indications on a trading platform. Techniques described herein may provide an automated price indication method and system that provides a graphical user interface with one or more user interface items representing an indication of price at various liquidity levels based upon a received size of an order. A communication module of a trading platform may periodically receive price information. A price module may automatically determine TOB price for a particular asset based upon the received price information. A processor may configure the display of the determined TOB price in a graphical user interface (GUI) of the trading platform. Order information may be received by the processor with respect to the particular asset. The price module may automatically determine a first near-TOB price and a second near-TOB price based upon the received order information and the periodically received pricing information. The processor may automatically configure the display of a first indication of the first near-TOB price in the GUI of the trading platform. The processor may configure the display of a second indication of the second near-TOB price in the GUI of the trading platform. The processor may receive an order indicating a trade at either the first near-TOB price or the second near-TOB price.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system.

FIG. 2 illustrates a logic flow according to an embodiment.

FIG. 3 illustrates a logic flow according to an embodiment.

FIG. 4 illustrates a logic flow according to an embodiment.

FIG. 5 illustrates a user interface according to an embodiment.

FIG. 6 illustrates a user interface according to an embodiment.

FIG. 7 illustrates a user interface according to an embodiment.

FIG. 8 illustrates a user interface according to an embodiment.

FIG. 9 illustrates a user interface according to an embodiment.

FIG. 10 illustrates a user interface according to an embodiment.

FIG. 11 illustrates a user interface according to an embodiment.

FIG. 12 illustrates an embodiment of a centralized system according to an embodiment.

FIG. 13 illustrates an embodiment of a distributed system according to an embodiment.

FIG. 14 illustrates an embodiment of a computing architecture.

FIG. 15 illustrates an embodiment of a communications architecture.

### DETAILED DESCRIPTION

Various embodiments are generally directed to techniques for automated price indications. Techniques described herein may provide a user interface on a trading platform that informs a user of pricing information on a real-time, or near real-time basis. Specifically, the techniques describes herein may provide traders with a user interface on a trading platform that provides information with respect to TOB pricing and near-TOB pricing to accomplish a trade that may be larger than TOB liquidity. The user interface may be configured on a display to allow users to place orders quickly based upon the determined price indications. In this manner, users may place trades for large orders more efficiently and effectively. The techniques described herein solve problems of prior GUI devices in the context of computerized trading, relating to speed, accuracy and usability, specifically in the area of quickly placing large orders that may be larger than TOB liquidity.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

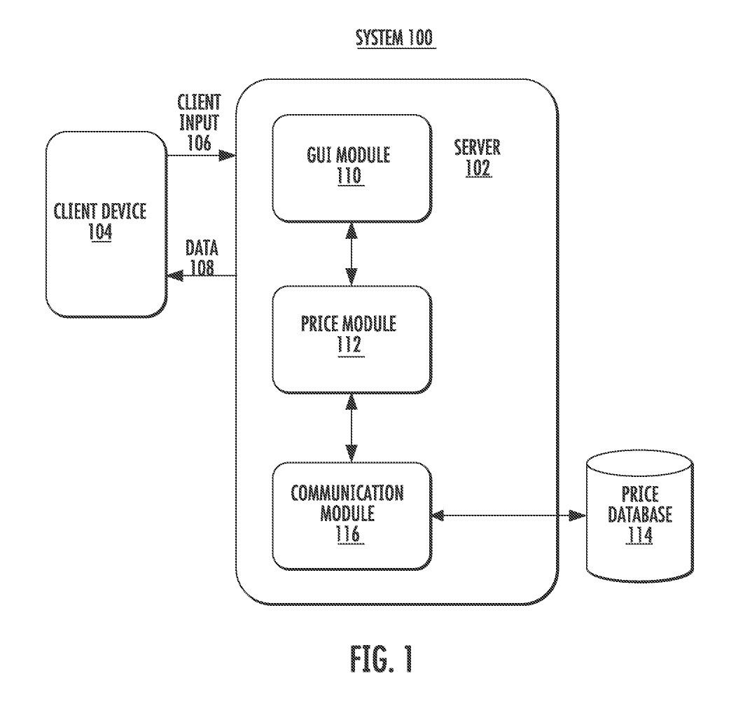

FIG. 1 illustrates a block diagram for a system 100. The system 100 may comprise one or more components configured to operate according to the embodiments and logic flows described herein. Although the system 100 shown in FIG. 1 has a limited number of elements in a certain topology, it may be appreciated that the system 100 may include more or less elements in alternate topologies as desired for a given implementation. The system 100 may include a server 102, which may be generally operative to interact with one or more components or modules within system 100. Server 102 may include one or more processing units, storage units, network interfaces, or other hardware and software elements, described in more detail below.

In an embodiment, each component may comprise a device, such as a server, comprising a network-connected storage device or multiple storage devices, such as one of the storage devices described in more detail herein. In an example, client device 104 may include one or more devices used to access software or web services provided by server 102. For example, client device 104 may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a wearable computing device such as a smart watch, a server, a server array or server farm, a web server, a network server, an Internet server, a work station, a mini-computer, a mainframe computer, a supercomputer, a network appliance, a web appliance, multiprocessor systems, processor-based systems, or any combination thereof.

In various embodiments, server 102 and the other components of system 100 may comprise or implement multiple components or modules. As used herein the terms “component” and “module” are intended to refer to computer-related entities, comprising either hardware, a combination of hardware and software, software, or software in execution. For example, a component and/or module can be implemented as a process running on a processor, a hard disk drive, multiple storage drives (of optical and/or magnetic storage medium), an object, an executable, a thread of execution, a program, and/or a computer. By way of illustration, both an application running on a server and the server can be a component and/or module. One or more components and/or modules can reside within a process and/or thread of execution, and a component and/or module can be localized on one computer and/or distributed between two or more computers as desired for a given implementation. The embodiments are not limited in this context.

The various devices within system 100, and components and/or modules within a device of system 100, may be communicatively coupled via various types of communications media as indicated by various lines or arrows. The devices, components and/or modules may coordinate operations between each other. The coordination may involve the uni-directional or bi-directional exchange of information. For instance, the devices, components and/or modules may communicate information in the form of non-transitory signals communicated over the communications media. The information can be implemented as signals allocated to various signal lines. In such allocations, each message is a signal. Further embodiments, however, may alternatively employ data messages. Such data messages may be sent across various connections. Exemplary connections within a device include parallel interfaces, serial interfaces, and bus interfaces. Exemplary connections between devices may comprise network connections over a wired or wireless communications network.

In various embodiments, the components and modules of the system 100 may be organized as a distributed system. A distributed system typically comprises multiple autonomous computers that communicate through a computer network. The computers interact with each other in order to achieve a common goal, such as solving computational problems. For example, a computational problem may be divided into many tasks, each of which is solved by one computer. A computer program that runs in a distributed system is called a distributed program, and distributed programming is the process of writing such programs. Examples of a distributed system may include, without limitation, a client-server architecture, a 3-tier architecture, an N-tier architecture, a tightly-coupled or clustered architecture, a peer-to-peer architecture, a master-slave architecture, a shared database architecture, and other types of distributed systems. It is worthy to note that although some embodiments may utilize a distributed system when describing various enhanced techniques for data retrieval, it may be appreciated that the enhanced techniques for data retrieval may be implemented by a single computing device as well. The embodiments are not limited in this context.

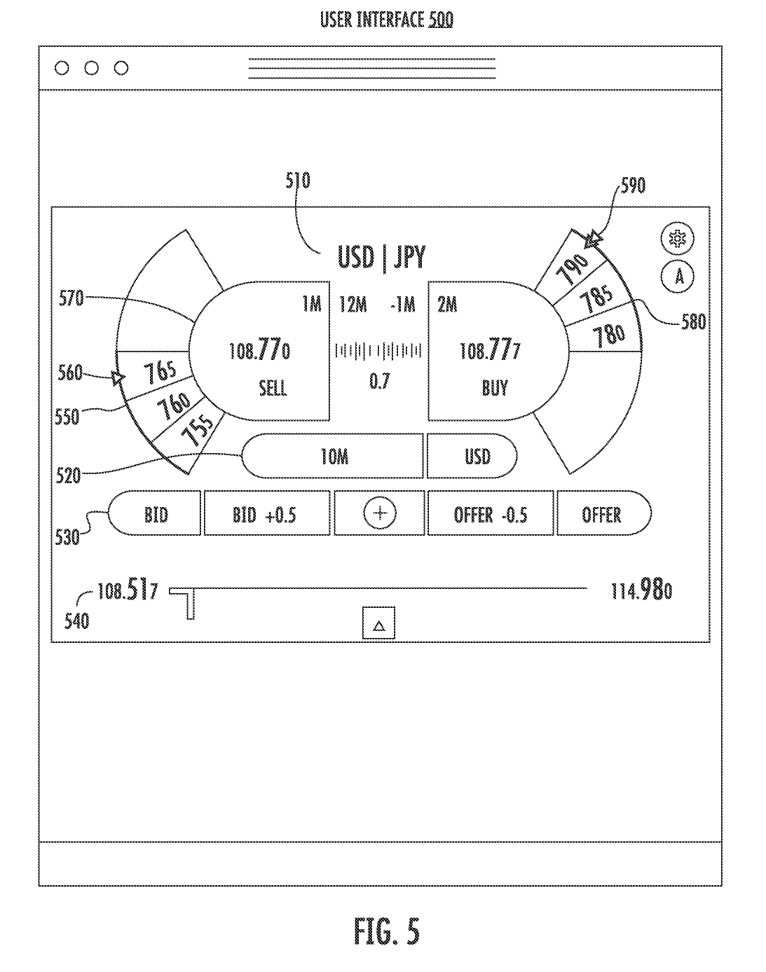

In an embodiment, client device 104 may include a display with a graphical user interface (GUI). As described in more detail herein, particularly with respect to FIGS. 5-11, the GUI may display user interface elements that represent a trading platform with automated price indications, which may be determined, at least in part, by prices communicated between communication module 116 and price database 114. In some embodiments, price database 114 may be locally stored on server 102 or client device 104, however, for illustrative purposes, price database 114 will be described as being stored on a non-transitory computer-readable storage medium remote from, but communicatively coupled to, server 102. Client device 104 may also include one or more input devices, described herein, such as a touch screen or mouse/keyboard. Using these input devices, a user of client device 104 may select one or more user interface elements of a GUI, which may send client input 106 to server 102. Client input 106 may include data indicating the selection of one or more user interface elements on client device 104, and may, in some embodiments, initiate an order based upon selection of one or more user interface elements.

In some embodiments, GUI module 110 of server 102 may configure the GUI of client device 104 with one or more user interface elements representing a trading platform with automated price indications based upon, at least in part, price data communicated to communication module 116 from price database 114. In some embodiments, user interface elements may vary in shape, color, and/or size based upon the type and/or design of a particular trading platform. User interface elements may have a variety of characteristics, such as size, color, shape, tag, field type, font, and others. For illustrative purposes and not by way of limitation, certain user interface elements are described in more detail herein with respect to FIGS. 5-11.

GUI element 110 may configure the display of a GUI on one or more client devices, such as client device 104. Exemplary user interface that may be configured by GUI element 110 may be included within FIGS. 5-11, discussed further herein. GUI module 110 may be configured to receive client input 106, which may include information with respect to the selection and/or placement of one or more user interface elements in a GUI. Client input 106 may also include information with respect to data associated with one or more user interface elements, such as, but not limited to, a particular asset to be traded, the amount to be traded, pricing information such as target or limit prices, increments for the display of pricing data, or other information that may be set by a user of a trading platform. In an embodiment, GUI module 110 may receive client input 106 that includes information with respect to an amount of an asset that a user would like to trade. In an embodiment, GUI module 110 may receive client input 106 that indicates an order should be placed.

GUI module 110 may communicate with price module 112 to share the received client input 106. For example, GUI module 110 may indicate to price module 112 the information contained within client input 106, such as order parameters including type of asset, amount of an asset, pricing information, target or limit prices, whether an order should be placed, and so on. GUI module 110 may be configured to automatically update the configuration of the GUI on client device 104 based upon responses from price module 112, as described herein.

In an embodiment, price module 112 may communicate with GUI module 110 to automatically generate price indications within a GUI of client device 104 according to the embodiments described herein. Price module 112 may be operated by one or more processors of server 102, and may automatically generate market price information and price indications based upon communicated user interactions from GUI module 110 and market price information from price database 114.

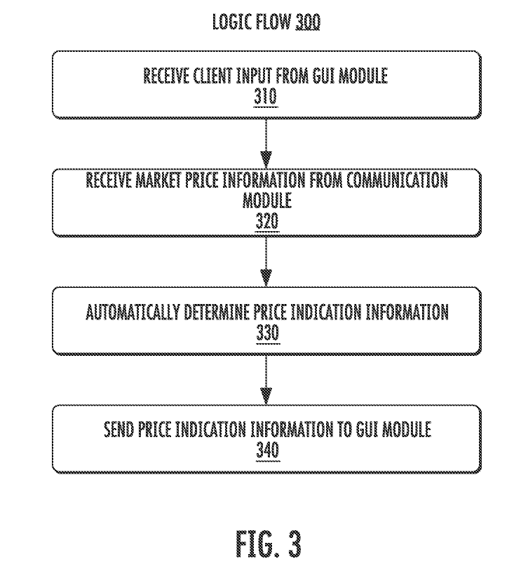

In an embodiment, price module 112 may receive client input 106 from GUI module 110, which may include parameters including type of asset, amount of an asset, pricing information, target or limit prices, or whether an order should be placed. Price module 112 may also receive market price information from price database 114 via communication module 116. Using a combination of client input 106 and market price information from price database 114, price module 112 may determine prices and price indications as described herein, particularly with respect to FIG. 3. Price module 112 may send GUI module 110 market price information, TOB price information, and near-TOB information, as described herein, such that GUI module 110 may configure the display of a user interface of a client device 104 according to the embodiments described with respect to FIGS. 5-11.

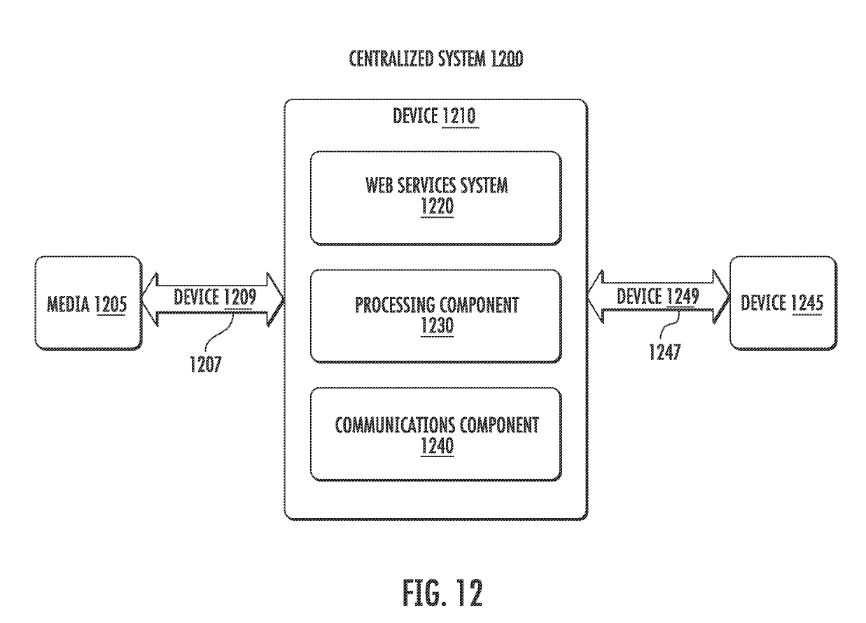

In an embodiment, communication module 116 may communicate with a price database 114. Communication module 116 may be similar to one or more of the communications components described herein with respect to FIGS. 12-15. Communication module 116 may periodically request market price information of one or more assets from price database 114. In some embodiments, price database 114 may be located remote from server 102 and may be one or more third-party market information services. In other embodiments, price database 114 may be within server 102. Communication module 116 may relay market price information to price module, and update price database with respect to executed orders in some embodiments.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer). For example, a logic flow may be implemented by a processor component executing instructions stored on an article of manufacture, such as a storage medium or a computer-program product. A storage medium may comprise any non-transitory computer-readable medium or machine-readable medium, such as an optical, magnetic or semiconductor storage. The storage medium may store various types of computer executable instructions, such as instructions to implement one or more disclosed logic flows. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The embodiments are not limited in this context.

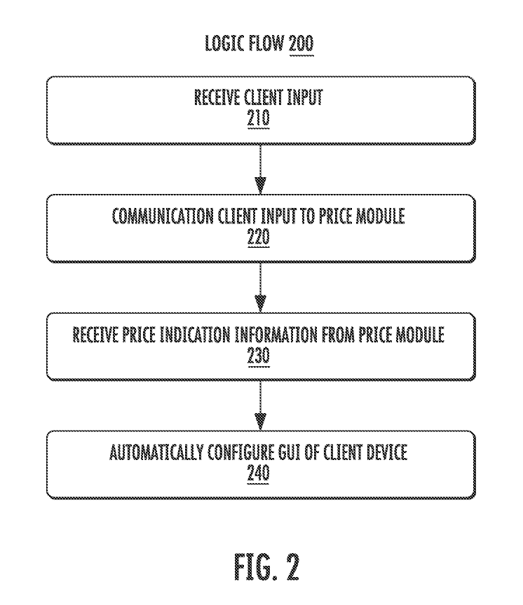

FIG. 2 illustrates one embodiment of a logic flow 200. The logic flow 200 may be representative of some or all of the operations executed by one or more embodiments described herein. For instance, the logic flow 200 may be representative of some or all of the operations executed by system 100, and the components and modules included therein. For example, and without limitation, some of the operations described by logic flow 200 may be implemented by GUI module 110.

At 210, a GUI module may be configured to receive client input, which may include information with respect to the selection and/or placement of one or more user interface elements in a GUI. Client input may also include information with respect to data associated with one or more user interface elements, such as, but not limited to, a particular asset to be traded, the amount to be traded, pricing information such as target or limit prices, increments for displayed prices, or other information that may be set by a user of a trading platform. In an embodiment, a GUI module may receive client input that includes information with respect to an amount of an asset that a user would like to trade. In an embodiment, a GUI module may receive client input that indicates an order should be placed.

At 220, a GUI module may communicate with a price module to share the received client input. For example, a GUI module may indicate to the price module the information contained within the client input, such as order parameters including type of asset, amount of an asset, pricing information, target or limit prices, whether an order should be placed, and so on.

At 230, a GUI module may be configured to receive price indication information from a price module. Price indication information may include various pricing data that may be used to configure the display of a user interface of a client device. For example, price indication information may include one or more TOB prices, one or more near-TOB prices, and data indicating which near TOB-prices should be identified within a user interface based upon at least the amount of an asset that may be traded.

At 240, a GUI module may be configured to automatically update the configuration of the GUI on a client device based upon responses from a price module, as described herein with respect to FIGS. 5-11.

FIG. 3 illustrates one embodiment of a logic flow 300. The logic flow 300 may be representative of some or all of the operations executed by one or more embodiments described herein. For instance, the logic flow 300 may be representative of some or all of the operations executed by system 100, and the components and modules included therein. For example, and without limitation, some of the operations described by logic flow 300 may be implemented by price module 112.

At 310, a price module may receive client input from a GUI module, which may include parameters including type of asset, amount of an asset, pricing information, target or limit prices, or whether an order should be placed.

At 320, a price module may receive market price information from price database via a communication module. Market price information may include one or more offers or bids for a particular asset, or for many assets, within a market. Market price information may further include timing information for the expiration of bids and offers and type information, identifying some offers as firm and other offers as last-look, as described further herein.

At 330, a price module may use a combination of client input and market price information from price database, price module to automatically determine price indication information, as illustrated and described herein with respect to FIGS. 5-11. In an embodiment, price module may determine one or more indications of a recommended price based upon one or more factors. By way of example, and not limitation, a price module may be configured to determine the following:

A=Quantity Specified by Customer as the Size of Intended Order

X1=Worst Rate Such That Σ(All Posted Orderbook Interest)≥A

X2=Worst Rate Such That (100%*Σ(All Posted Orderbook Interest)+80%*Σ(Last Look Orderbook Interest))≥120%*A

Based upon the determinations made by price module above, an exemplary automatic price indication may be determined by a pricing module as follows. In the example set forth within Table 1 below, if a customer has set their order size for “40 M”, the formula for X1 (TOB or near-TOB) may look at all liquidity equally, and find the worst or clearing price where 40 M is available, which in this case is 9.7 (since only 30 M is available at 9.8, the pricing module needs to go deeper into the orderbook to source additional liquidity). Moreover, given the potential for misses on any order and rejects on last look, as discussed herein, the formula for X2 (TOB or near-TOB) has a more conservative calculation of a worst price of 9.5 (120% of 40 M=48 M, and to get 48 M+ using the 80% factor on last look liquidity, it requires going down to 9.5 in the orderbook). The above example is meant for purposes of illustration and not limitation. Other values may be used for orders and, of course, some of the variables used, such as 80% and 120% may be modified in certain embodiments, either by the user or administrator of the system.

TABLE 1

| | | | Last | | | 100% |
|---|---|---|---|---|---|---|
| Bid | Firm | Cumulative | Look | Cumulative | Overall | Firm + |
| Price | Size | Firm | Size | LL | Cumulative | 80% LL |
| 10 | 0M | 0M | 5M | 5M | 5M | 4M |
| 9.9 | 1M | 1M | 10M | 15M | 16M | 13M |
| 9.8 | 4M | 5M | 10M | 25M | 30M | 25M |
| 9.7 | 5M | 10M | 10M | 35M | 45M | 38M |
| 9.6 | 5M | 15M | 5M | 40M | 55M | 47M |
| 9.5 | 10M | 25M | 0M | 40M | 65M | 57M |

At 340, a price module may send a GUI module price indication information, along with market price information, TOB price information, and near-TOB information, as described herein, such that a GUI module may configure the display of a user interface of a client device according to the embodiments described with respect to FIGS. 5-11.

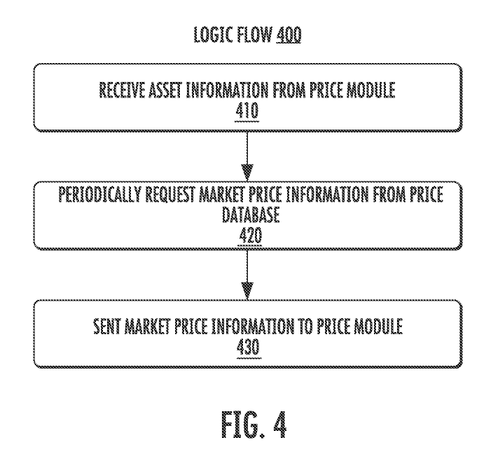

FIG. 4 illustrates one embodiment of a logic flow 400. The logic flow 400 may be representative of some or all of the operations executed by one or more embodiments described herein. For instance, the logic flow 400 may be representative of some or all of the operations executed by system 100, and the components and modules included therein. For example, and without limitation, some of the operations described by logic flow 400 may be implemented by communication module 114.

At 410, a communication module may receive asset information from a price module, which may include types of an asset, amounts of an asset, or other information required to request market price information from a price database, which is done periodically at 420. The period of requests may be quite fast, measured in ms, in some embodiments. In this manner, near real-time market price information may be sent to a price module at 430 and used by the price module to automatically configure price indications on a user interface of a client device.

FIG. 5 illustrates a user interface 500 according to an embodiment. User interface 500 may be part of a trading platform for the trading of one or more asset classes. Specifically, user interface 500 may be part of a GUI of a trading platform and may make up a portion of the GUI, or may constitute a standalone GUI in some embodiments. User interface 500 may include one or more user interface elements. While some user interface elements may be specifically described with respect to certain embodiments, more or less of the illustrated user interface elements may be present within an embodiment. User interface 500 may be generated by a processor of a client device and displayed on a display of the client device based upon configuration information sent from a server, as described herein.

In some embodiments, user interface 500 may include one or more user interface elements identifying asset classes, quantities, types of orders, and/or prices. Some or all of this information may be entered by a user and stored within a computer-readable storage medium of a client device or server. In some embodiments, some or all of this information may be communicated to a server, as described herein, so that user interface 500 may be configured to display automated price indications.

In an embodiment, user interface 500 may include a user interface element 510, which may identify a class of assets that are to be traded on a trading platform. For purposes of illustration and not limitation, user interface element 510 identifies USD|JPY in a FOREX trading platform. It can be appreciated, however, that other types of asset classes may be used with the embodiments described herein. As illustrated, user interface element 520 identifies an amount to be traded, in this case, 10 M USD. User interface 500 may also include user interface 530, which may identify whether the trade is a bid or an offer, and an amount for which incremental prices should be displayed, which may be user-settable, or default. Here, the amount for which incremental prices should be displayed is every 0.5 pip, however, it can be appreciated that other amounts and units may be used in some embodiments.

User interface 500 may include one or more user interface elements that are automatically configured by a price module of a server based upon a variety of criteria including, but not limited to, information received from a user of user interface 500 and price information received by a server. User interface 500 may include user interface element 540, which may include a price range that is set by the user, or may be a system default. User interface element 570 may represent a TOB price for a particular amount of an asset, here, 1 M. User interface elements 550 and 580 may include a list of prices generated by a price module, as described herein. The prices displayed within user interface elements 550 and 580 may be within a range displayed within user interface element 540, for example. In some embodiments, user interface element 540 may illustrate a sparkline showing the high-low range of prices through a period of time, such as a directly preceding 24-hour time period.

Within user interface elements 550 and 580, additional user interface elements may be automatically configured for display. Within user interface element 550, an indicator 560 may indicate one of a plurality of prices. Indicator 560 may indicate a price determined by a price module of a server. In an embodiment, a price module may take into account an amount of an asset received via user input and communication to a GUI module of the server, for example. As previously discussed, a determined TOB price may be for a particular amount of an asset, however, the TOB price may not offer liquidity above that particular amount. A trader may wish to trade more than the TOB price liquidity may support and, thus, may need to trade at a near-TOB price to complete the order (i.e. at a price greater than the touch offer, or lower than the touch bid).

In some embodiments, different types of automated price indicators may provide different information to a user about the current near real-time trading environment. A first type of indicator, such as indicator 560, may indicate a first near-TOB price where 100% of a loaded order may be executed. In some type of asset markets, there may be different types of offers. For example, an offer may be firm (or required to be executed) or a last-look offer (giving the offeree a chance to reject a request for execution (RFE)). Thus, a second type of indicator, which may look different than the first type, may indicate a second near-TOB price at which some amount greater than 100% of the order may be executed. In this manner, some additional safeguard is built into the indicator such that an order may have a greater chance of fully being executed, even if some percentage of last-look offers lead to rejections. The algorithm for this may give last-look orders a presumed percentage of execution, such as 80%, or another value derived from historical data on trade-fulfillment rates. In some embodiments, the percentage above 100% may be fixed, such as 120%, or can be dynamically configured based upon a variety of factors. A third type of indicator, such as indicator 590, may indicate a near-TOB price at which both 100% of an order size and some percentage above 100% may be executed.

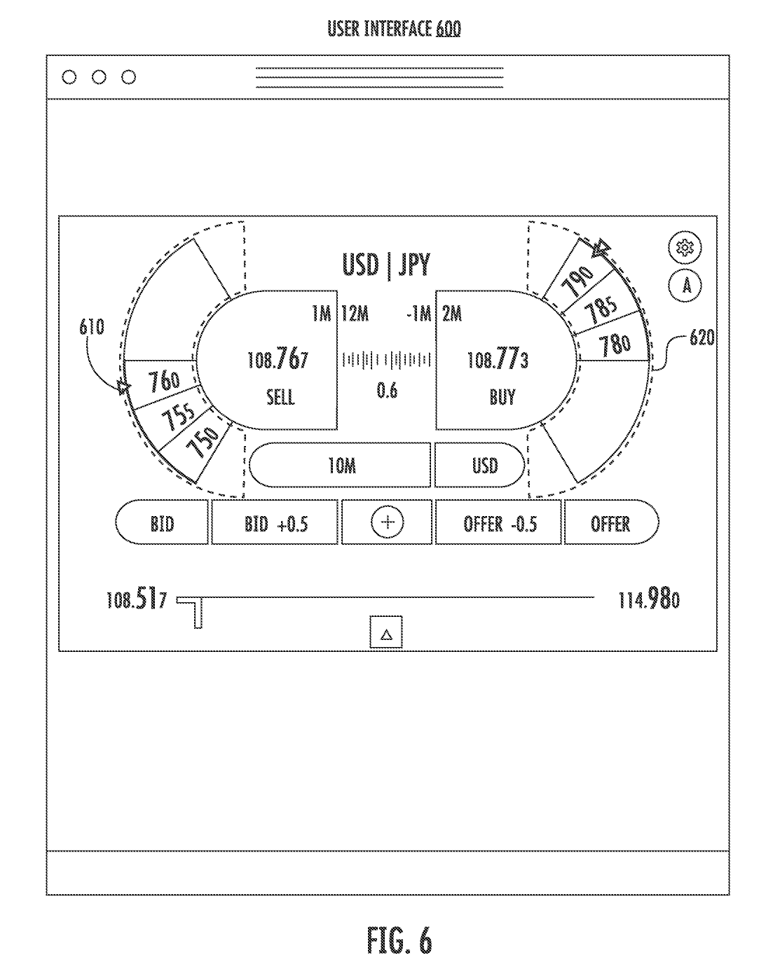

FIG. 6 illustrates a user interface 600 according to an embodiment. User interface 600 may be part of a trading platform for the trading of one or more asset classes. Specifically, user interface 600 may be part of a GUI of a trading platform and may make up a portion of the GUI, or may constitute a standalone GUI in some embodiments. User interface 600 may include one or more user interface elements. While some user interface elements may be specifically described with respect to certain embodiments, more or less of the illustrated user interface elements may be present within an embodiment. User interface 600 may be generated by a processor of a client device and displayed on a display of the client device based upon configuration information sent from a server, as described herein.

In some embodiments, user interface 600 may include one or more user interface elements identifying asset classes, quantities, types of orders, and/or prices. Some or all of this information may be entered by a user and stored within a computer-readable storage medium of a client device or server. In some embodiments, some or all of this information may be communicated to a server, as described herein, so that user interface 600 may be configured to display automated price indications.

In an embodiment, user interface 600 may include a user interface elements 610 and 620, which may identify a ladder of prices near-TOB for a given order amount. User interface elements 610 and 620 may be a “quick click” zone in which a user may hover over any listed price and “click” submit an order at that price. A “click” may be user-defined as a preference in the system as a single-click or a double-click, in some embodiments. The prices within a “quick click” zone may be color-coded in some embodiments. Once selected, information, such as the selected price and order information (price, type of asset, etc.) may be communicated to a server for order execution. In an embodiment, user interface elements 610 and 620 may remain permanently open with the GUI of a trading platform. However, in other embodiments, one or both of user interface elements 610 and 620 may be hidden until a user interaction, such as clicking a TOB price, triggers their display.

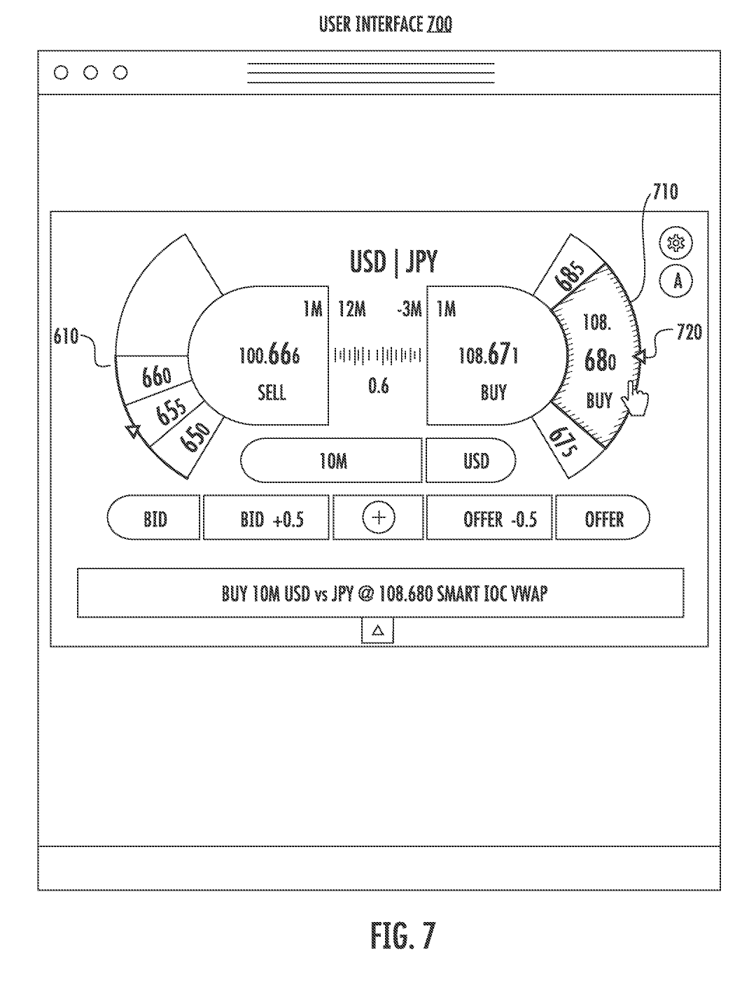

FIG. 7 illustrates a user interface according to an embodiment. User interface 700 may be part of a trading platform for the trading of one or more asset classes. Specifically, user interface 700 may be part of a GUI of a trading platform and may make up a portion of the GUI, or may constitute a standalone GUI in some embodiments. User interface 700 may include one or more user interface elements. While some user interface elements may be specifically described with respect to certain embodiments, more or less of the illustrated user interface elements may be present within an embodiment. User interface 700 may be generated by a processor of a client device and displayed on a display of the client device based upon configuration information sent from a server, as described herein.

In some embodiments, user interface 700 may include one or more user interface elements identifying asset classes, quantities, types of orders, and/or prices. Some or all of this information may be entered by a user and stored within a computer-readable storage medium of a client device or server. In some embodiments, some or all of this information may be communicated to a server, as described herein, so that user interface 700 may be configured to display automated price indications.

In some embodiments, user interface 700 may include user interface elements 710 and 720, which may illustrate a GUI when a user hovers a user input device, such as a mouse cursor or a fingertip on a touchscreen, on a price within a “quick click” zone of user interface 700. As illustrated, user interface element 710 highlights a particular price, provides an indication that clicking will BUY, or submit an order, and may include other automated user interface elements indicating price. In an example, user interface element 720 may indicate that 100% of an order, such as 1 M, may be executed by clicking. In other embodiments, other automated price indicators may be disclosed as discussed with respect to FIG. 5.

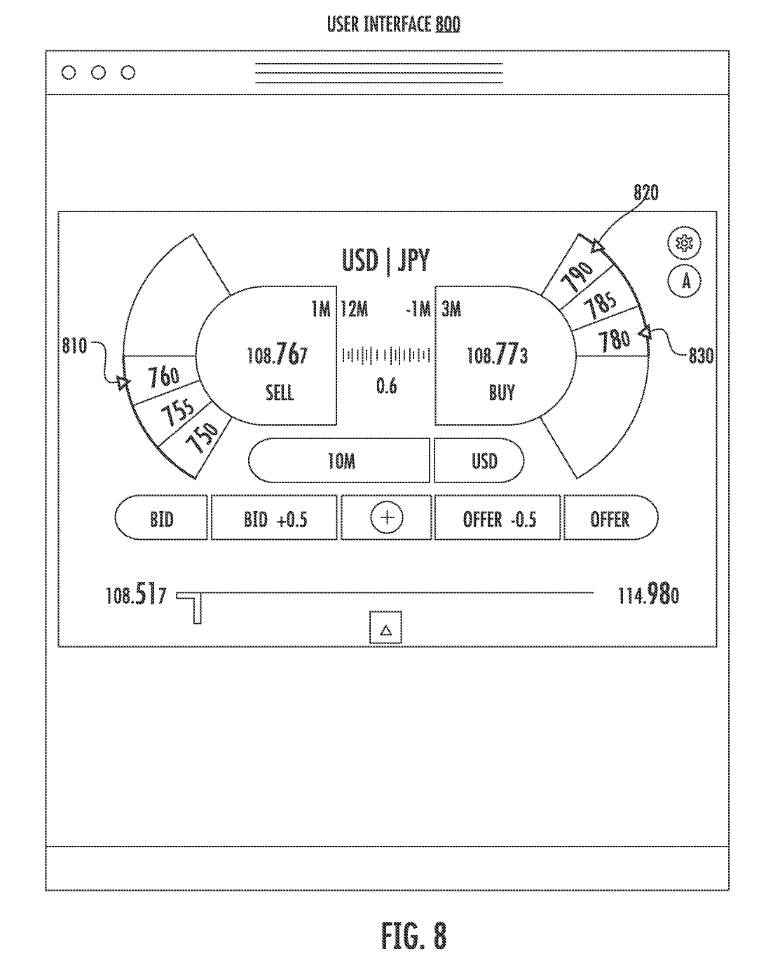

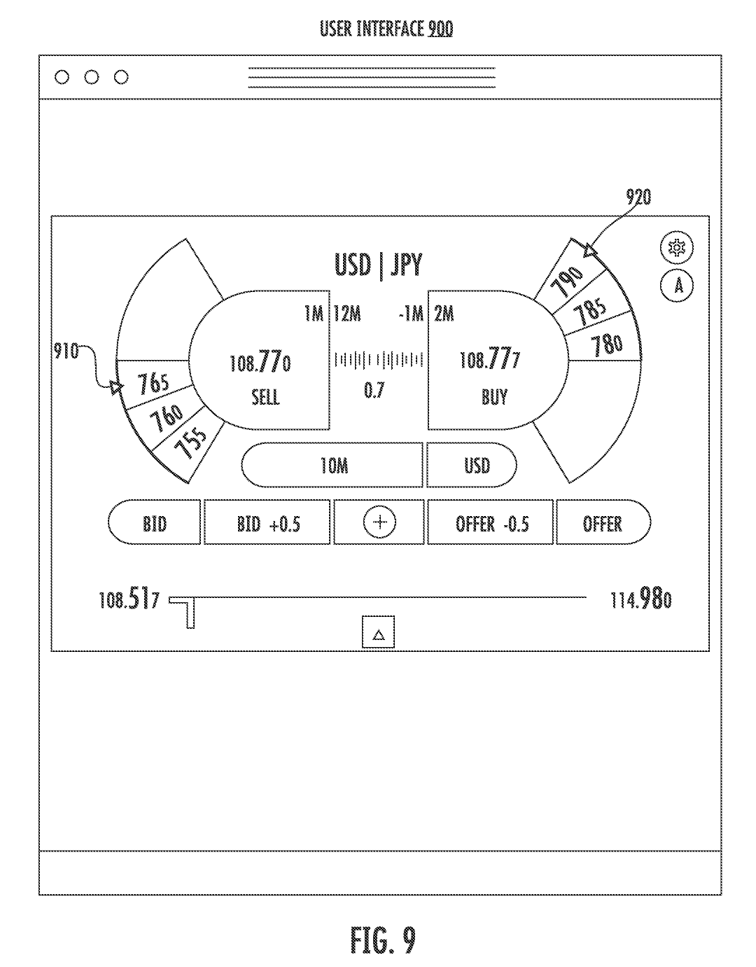

FIGS. 8-9 illustrate user interfaces 800 and 900, respectively, according to an embodiment. User interfaces 800 and 900 may be part of a trading platform for the trading of one or more asset classes. Specifically, user interfaces 800 and 900 may be part of a GUI of a trading platform and may make up a portion of the GUI, or may constitute a standalone GUI in some embodiments. User interfaces 800 and 900 may include one or more user interface elements. While some user interface elements may be specifically described with respect to certain embodiments, more or less of the illustrated user interface elements may be present within an embodiment. User interfaces 800 and 900 may be generated by a processor of a client device and displayed on a display of the client device based upon configuration information sent from a server, as described herein.

In some embodiments, user interfaces 800 and 900 may include one or more user interface elements identifying asset classes, quantities, types of orders, and/or prices. Some or all of this information may be entered by a user and stored within a computer-readable storage medium of a client device or server. In some embodiments, some or all of this information may be communicated to a server, as described herein, so that user interface 800 may be configured to display automated price indications.

In an embodiment, user interface 800 may include a user interface elements 810, 820 and 830, and user interface 900 may include user interface elements 910 and 920, which may be automatically configured by a price module of a server based upon a variety of criteria including, but not limited to, information received from a user of user interfaces 800 and/or 900 and price information received by a server. User interface elements 810, 820, 830, 910, and 920 may indicate one of a plurality of prices. Indicators 810, 820, 830, 910, and 920 may indicate a price determined by a price module of a server. In an embodiment, a price module may take into account an amount of an asset received via user input and communication to a GUI module of the server, for example. As previously discussed, a determined TOB price may be for a particular amount of an asset, however, the TOB price may not offer liquidity above that particular amount. A trader may wish to trade more than the TOB price liquidity may support and, thus, may need to trade “through” TOB price to complete the order.

In some embodiments, different types of automated price indicators may provide different information to a user about the current near real-time trading environment. A first type of indicator, such as indicators 810, 830 and 910, may indicate a first near-TOB price where 100% of a loaded order may be executed. In some type of asset markets, there may be different types of offers. For example, an offer may be firm (or required to be executed) or a last-look offer (giving the offeree a chance to reject). Thus, a second type of indicator, such as indicator 820, which may look different than the first type, may indicate a second near-TOB price at which some amount greater than 100% of the order may be executed. In this manner, some additional safeguard is built into the indicator such that an order may have a greater chance of fully being executed, even if some percentage of last-look offers reject. In some embodiments, the percentage above 100% may be fixed, such as 120%, or can be dynamically configured based upon a variety of factors. A third type of indicator, such as illustrated within FIG. 9 by indicator 920, may indicate a near-TOB price at which both 100% of an order size and some percentage above 100% may be executed.

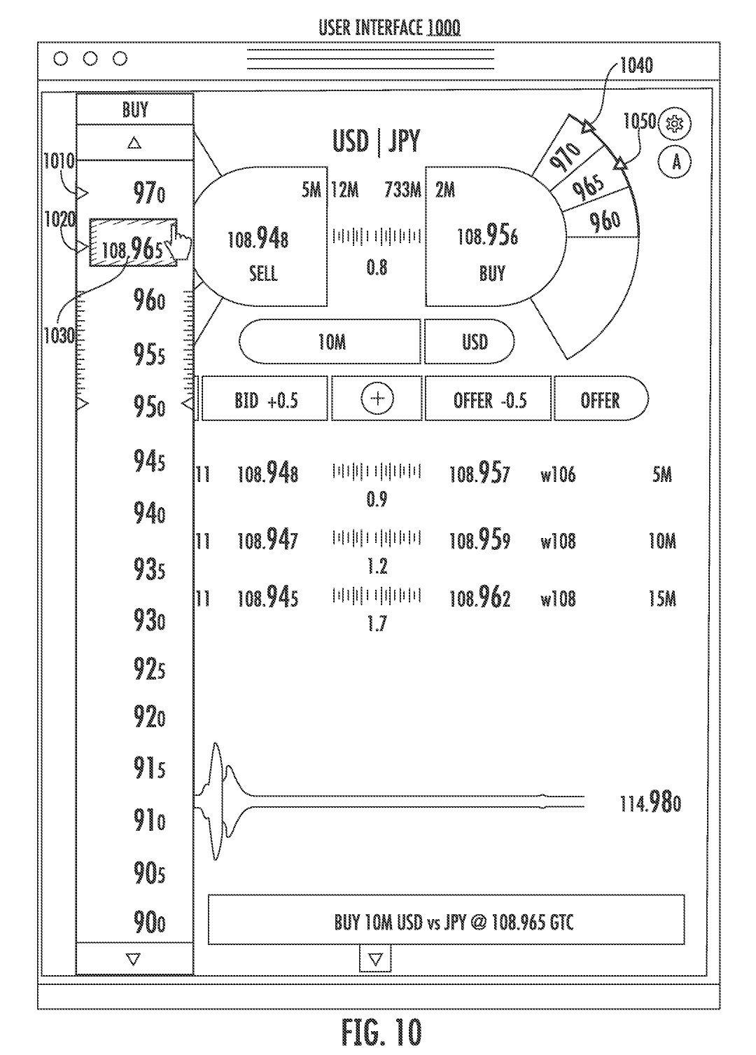

FIG. 10 illustrates a user interface according to an embodiment. The user interface 1000 illustrated in FIG. 10 may include many similar user interface elements as FIG. 5 and FIG. 8, but may be presented in a different manner. For example, user interface elements 1020 and 1050 may correspond to indicator 560 of FIG. 5. User interface elements 1010 and 1040 may correspond to indicator 820 of FIG. 8. Likewise, user interface element 1030 may correspond to an automatically configured TOB price in a similar manner to that of user interface element 570 of FIG. 5, described above.

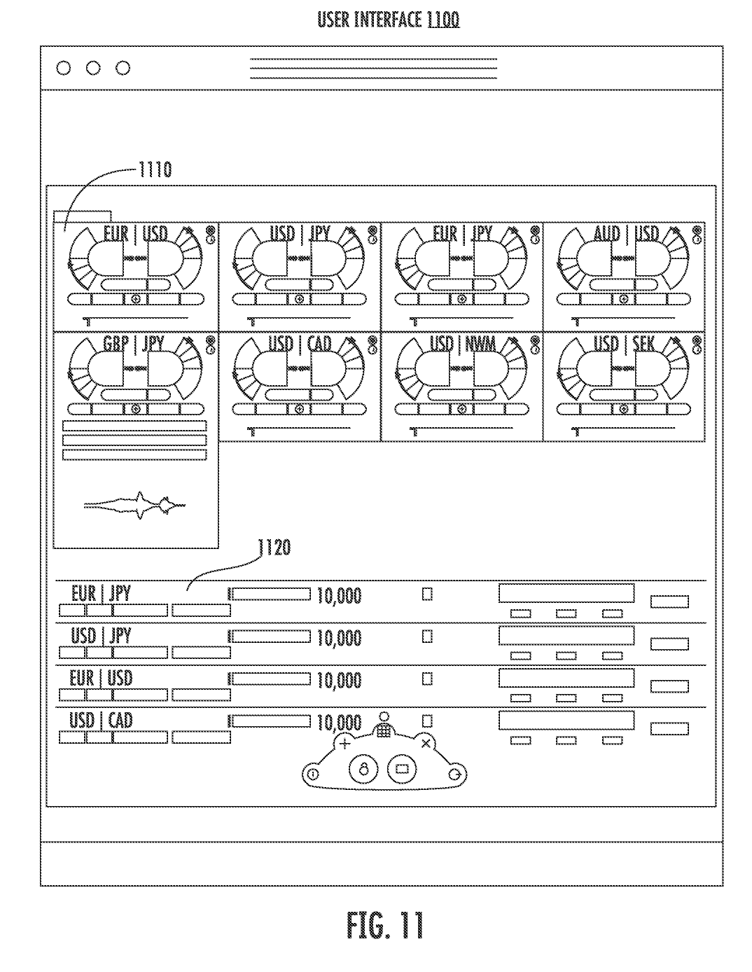

FIG. 11 illustrates a user interface according to an embodiment. As set forth above, the user interfaces described herein may correspond to a portion of a larger user interface, or may constitute the entirety of a user interface. FIG. 11 illustrates an embodiment in which user interface 1110 is one of many user interfaces, which each may be individually set and managed by a user of user interface 1100. For example, each of user interfaces 1110 may correspond to a different asset, asset class, order amount, or target price, as some examples. In addition, an order activity and trade blotter section 1120 may allow a user to view one or more orders and/or trades.

FIG. 12 illustrates a block diagram of a centralized system 1200. The centralized system 1200 may implement some or all of the structure and/or operations for the web services system 1220 in a single computing entity, such as entirely within a single device 1210.

The device 1210 may comprise any electronic device capable of receiving, processing, and sending information for the web services system 1220. Examples of an electronic device may include without limitation a computer, a personal computer (PC), a desktop computer, a laptop computer, a notebook computer, a netbook computer, a handheld computer, a tablet computer, a server, a server array or server farm, a web server, a network server, an Internet server, a work station, a main frame computer, a supercomputer, a network appliance, a web appliance, a distributed computing system, multiprocessor systems, processor-based systems, wireless access point, base station, subscriber station, radio network controller, router, hub, gateway, bridge, switch, machine, or combination thereof. The embodiments are not limited in this context.

The device 1210 may execute processing operations or logic for the web services system 1220 using a processing component 1230. The processing component 1230 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 1210 may execute communications operations or logic for the web services system 1220 using communications component 1240. The communications component 1240 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 1240 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 1209, 1249 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 1210 may communicate with other devices 1205, 1245 over a communications media 1209, 1249, respectively, using communications signals 1207, 1247, respectively, via the communications component 1240. The devices 1205, 1245, may be internal or external to the device 1210 as desired for a given implementation. Examples of devices 1205, 1245 may include, but are not limited to, a mobile device, a personal digital assistant (PDA), a mobile computing device, a smart phone, a telephone, a digital telephone, a cellular telephone, ebook readers, a handset, a one-way pager, a two-way pager, a messaging device, consumer electronics, programmable consumer electronics, game devices, television, digital television, or set top box.

For example, device 1205 may correspond to a client device such as a phone used by a user. Signals 1207 sent over media 1209 may therefore comprise communication between the phone and the web services system 1220 in which the phone transmits a request and receives a web page in response.

Device 1245 may correspond to a second user device used by a different user from the first user, described above. In one embodiment, device 1245 may submit information to the web services system 1220 using signals 1247 sent over media 1249 to construct an invitation to the first user to join the services offered by web services system 1220. For example, if web services system 1220 comprises a social networking service, the information sent as signals 1247 may include a name and contact information for the first user, the contact information including phone number or other information used later by the web services system 1220 to recognize an incoming request from the user. In other embodiments, device 1245 may correspond to a device used by a different user that is a friend of the first user on a social networking service, the signals 1247 including status information, news, images, or other social-networking information that is eventually transmitted to device 1205 for viewing by the first user as part of the social networking functionality of the web services system 1220.

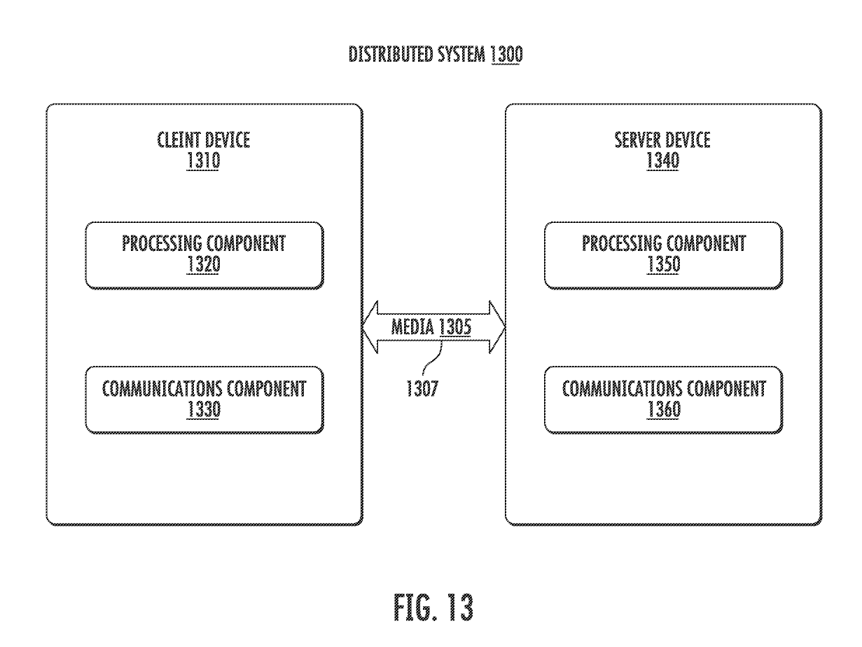

FIG. 13 illustrates a block diagram of a distributed system 1300. The distributed system 1300 may distribute portions of the structure and/or operations for the disclosed embodiments across multiple computing entities. Examples of distributed system 1300 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 1300 may comprise a client device 1310 and a server device 1340. In general, the client device 1310 and the server device 1340 may be the same or similar to device 1210 as described with reference to FIG. 12. For instance, the client device 1310 and the server device 1340 may each comprise a processing component 1320, 1350 and a communications component 1330, 1360 which are the same or similar to the processing component 1230 and the communications component 1240, respectively, as described with reference to FIG. 12. In another example, the devices 1310 and 1340 may communicate over a communications media 1305 using media 1305 via signals 1307.

The client device 1310 may comprise or employ one or more client programs that operate to perform various methodologies in accordance with the described embodiments. In one embodiment, for example, the client device 1310 may implement some steps described with respect client devices described in the preceding figures.

The server device 1340 may comprise or employ one or more server programs that operate to perform various methodologies in accordance with the described embodiments. In one embodiment, for example, the server device 1340 may implement some steps described with respect to server devices described in the preceding figures

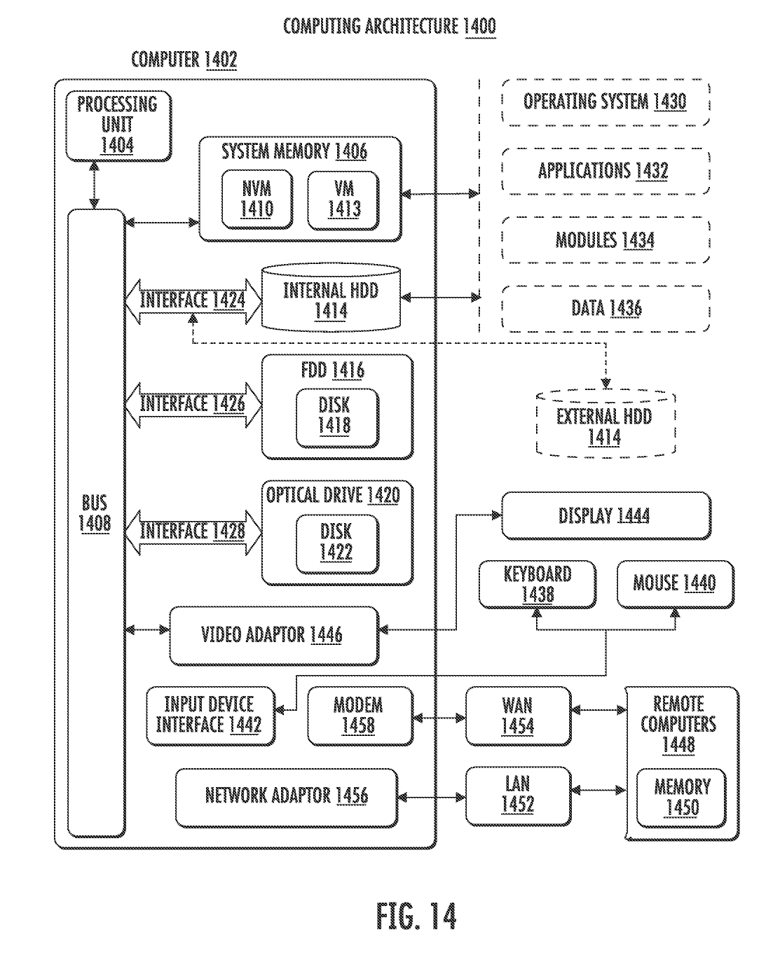

FIG. 14 illustrates an embodiment of an exemplary computing architecture 1400 suitable for implementing various embodiments as previously described. In one embodiment, the computing architecture 1400 may comprise or be implemented as part of an electronic device. Examples of an electronic device may include those described herein. The embodiments are not limited in this context.

As used in this application, the terms “system” and “component” are intended to refer to a computer-related entity, either hardware, a combination of hardware and software, software, or software in execution, examples of which are provided by the exemplary computing architecture 1400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1400 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1200.

As shown in FIG. 14, the computing architecture 1400 comprises a processing unit 1404, a system memory 1406 and a system bus 1408. The processing unit 1404 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1404.

The system bus 1408 provides an interface for system components including, but not limited to, the system memory 1406 to the processing unit 1404. The system bus 1408 can be any of several types of bus structure that may further interconnect to a memory bus (with or without a memory controller), a peripheral bus, and a local bus using any of a variety of commercially available bus architectures. Interface adapters may connect to the system bus 1408 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1400 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1406 may include various types of computer-readable storage media in the form of one or more higher speed memory units, such as read-only memory (ROM), random-access memory (RAM), dynamic RAM (DRAM), Double-Data-Rate DRAM (DDRAIVI), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 14, the system memory 1406 can include non-volatile memory 1410 and/or volatile memory 1413. A basic input/output system (BIOS) can be stored in the non-volatile memory 1410.

The computer 1402 may include various types of computer-readable storage media in the form of one or more lower speed memory units, including an internal (or external) hard disk drive (HDD) 1414, a magnetic floppy disk drive (FDD) 1416 to read from or write to a removable magnetic disk 1418, and an optical disk drive 1420 to read from or write to a removable optical disk 1422 (e.g., a CD-ROM, DVD, or Blu-ray). The HDD 1414, FDD 1416 and optical disk drive 1420 can be connected to the system bus 1408 by a HDD interface 1424, an FDD interface 1426 and an optical drive interface 1428, respectively. The HDD interface 1424 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1410, 1413, including an operating system 1430, one or more application programs 1432, other program modules 1434, and program data 1436. In one embodiment, the one or more application programs 1432, other program modules 1434, and program data 1436 can include, for example, the various applications and/or components to implement the disclosed embodiments.

A user can enter commands and information into the computer 1402 through one or more wire/wireless input devices, for example, a keyboard 1438 and a pointing device, such as a mouse 1440. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1404 through an input device interface 1442 that is coupled to the system bus 1408, but can be connected by other interfaces such as a parallel port, IEEE 1394 serial port, a game port, a USB port, an IR interface, and so forth.

A display 1444 is also connected to the system bus 1408 via an interface, such as a video adaptor 1446. The display 1444 may be internal or external to the computer 1402. In addition to the display 1444, a computer typically includes other peripheral output devices, such as speakers, printers, and so forth.

The computer 1402 may operate in a networked environment using logical connections via wire and/or wireless communications to one or more remote computers, such as a remote computer 1448. The remote computer 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wire/wireless connectivity to a local area network (LAN) 1452 and/or larger networks, for example, a wide area network (WAN) 1454. Such LAN and WAN networking environments are commonplace in offices and companies, and facilitate enterprise-wide computer networks, such as intranets, all of which may connect to a global communications network, for example, the Internet.

When used in a LAN networking environment, the computer 1402 is connected to the LAN 1452 through a wire and/or wireless communication network interface or adaptor 1456. The adaptor 1456 can facilitate wire and/or wireless communications to the LAN 1452, which may also include a wireless access point disposed thereon for communicating with the wireless functionality of the adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wire and/or wireless device, connects to the system bus 1408 via the input device interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

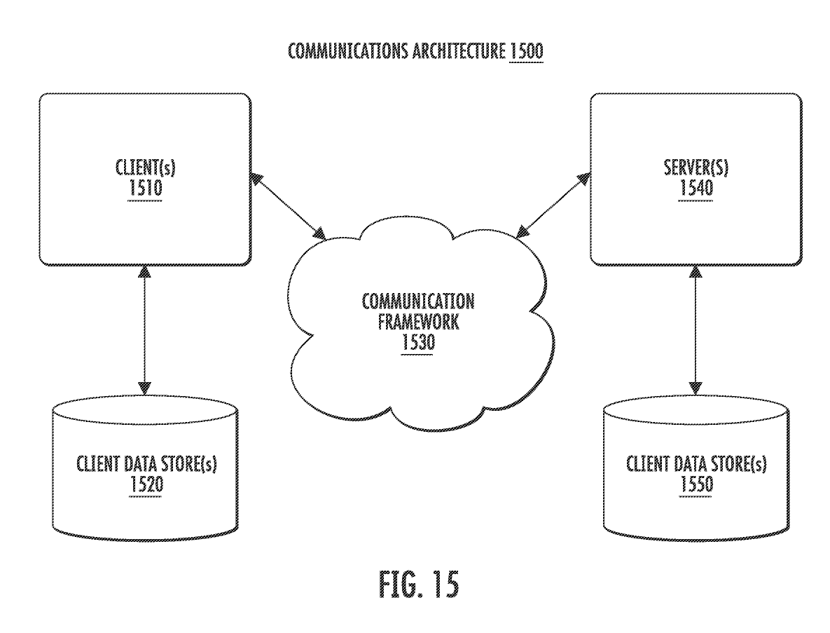

FIG. 15 illustrates a block diagram of an exemplary communications architecture 1300 suitable for implementing various embodiments as previously described. The communications architecture 1500 includes various common communications elements, such as a transmitter, receiver, transceiver, radio, network interface, baseband processor, antenna, amplifiers, filters, power supplies, and so forth. The embodiments, however, are not limited to implementation by the communications architecture 1500.

As shown in FIG. 15, the communications architecture 1500 comprises includes one or more clients 1510 and servers 1540. The clients 1510 may implement the client device 1510, for example. The servers 1540 may implement the server device 1540, for example. The clients 1510 and the servers 1540 are operatively connected to one or more respective client data stores 1520 and server data stores 1550 that can be employed to store information local to the respective clients 1510 and servers 1540, such as cookies and/or associated contextual information.

The clients 1510 and the servers 1540 may communicate information between each other using a communication framework 1530. The communications framework 1530 may implement any well-known communications techniques and protocols. The communications framework 1530 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1530 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1510 and the servers 1540. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible.

1. A computer-implemented method, comprising:
periodically receiving price information by a communication module of a trading platform;
automatically, by a price module, determining a top of book (TOB) price for a particular asset based upon the received price information;
configuring, by a processor, the display of the determined TOB price in a graphical user interface (GUI) of the trading platform;
receiving, by the processor, order information with respect to the particular asset;
automatically, by the price module, determining a first near-TOB price and a second near-TOB price based upon the received order information and the periodically received pricing information;
automatically, by the processor, configuring the display of a first indication of the first near-TOB price in the GUI of the trading platform;
automatically, by the processor, configuring the display of a second indication of the second near-TOB price in the GUI of the trading platform;
receiving, by the processor, an order indicating a trade at either the first near-TOB price or the second near-TOB price.

2. The computer-implemented method of claim 1, wherein the received order information includes an amount of the particular asset to be traded.

3. The computer-implemented method of claim 2, wherein the first indication of the first near-TOB price identifies a price at which 100% of the amount is available to fill an order at the first near-TOB price.

4. The computer-implemented method of claim 2, wherein the second indication of the second near-TOB price identifies a price at which more than 100% of the amount is available to fill an order at the second near-TOB price.

5. The computer-implemented method of claim 4, wherein the second indication of the second near-TOB price takes into account at least price information including firm liquidity and last-look liquidity to generate a model of expected fill amount.

6. The computer-implemented method of claim 1, wherein the particular asset is a unit of foreign exchange.

7. A system, comprising:
a processor;
a non-transitory computer-readable storage medium including instructions directing the processor to:
periodically receive price information;
automatically determine a top of book (TOB) price for a particular asset based upon the received price information;
configure the display of the determined TOB price in a graphical user interface (GUI);
receive order information with respect to the particular asset;
automatically determine a first near-TOB price and a second near-TOB price based upon the received order information and the periodically received pricing information;
automatically configure the display of a first indication of the first near-TOB price in the GUI;
automatically configure the display of a second indication of the second near-TOB price in the GUI;
receiving an order indicating a trade at either the first near-TOB price or the second near-TOB price.

8. The system of claim 7, wherein the received order information includes an amount of the particular asset to be traded.

9. The system of claim 8, wherein the first indication of the first near-TOB price identifies a price at which 100% of the amount is available to fill an order at the first near-TOB price.

10. The system of claim 8, wherein the second indication of the second near-TOB price identifies a price at which more than 100% of the amount is available to fill an order at the second near-TOB price.

11. The system of claim 10, wherein the second indication of the second near-TOB price takes into account at least price information including firm liquidity and last-look liquidity to generate a model of expected fill amount.

12. The system of claim 7, wherein the particular asset is a unit of foreign exchange.

13. An article including a computer-readable storage medium including instructions, that, when executed by a processor, cause the processor to:
periodically receive price information;
automatically determine a top of book (TOB) price for a particular asset based upon the received price information;
configure the display of the determined TOB price in a graphical user interface (GUI);
receive order information with respect to the particular asset;
automatically determine a first near-TOB price and a second near-TOB price based upon the received order information and the periodically received pricing information;
automatically configure the display of a first indication of the first near-TOB price in the GUI;
automatically, by the processor, configuring the display of a second indication of the second near-TOB price in the GUI of the trading platform;
receiving, by the processor, an order indicating a trade at either the first near-TOB price or the second near-TOB price.

14. The article of claim 1, wherein the received order information includes an amount of the particular asset to be traded.

15. The article of claim 14, wherein the first indication of the first near-TOB price identifies a price at which 100% of the amount is available to fill an order at the first near-TOB price.

16. The article of claim 14, wherein the second indication of the second near-TOB price identifies a price at which more than 100% of the amount is available to fill an order at the second near-TOB price.

17. The article of claim 16, wherein the second indication of the second near-TOB price takes into account at least price information including firm liquidity and last-look liquidity to generate a model of expected fill amount.

18. The article of claim 13, wherein the particular asset is a unit of foreign exchange.

19. An apparatus, comprising:
a processor;
a display device configured by the processor to generate a graphical user interface including:
a top of book (TOB) price for a particular asset automatically determined based upon periodic price information;
a first near-TOB price and a second near-TOB price automatically determined based upon received order information and the periodic price information;
a first indication of the first near-TOB price; and
a second indication of the second near-TOB price.

20. The apparatus of claim 19, wherein the received order information includes an amount of the particular asset to be traded.

21. The apparatus of claim 20, wherein the first indication of the first near-TOB price identifies a price at which 100% of the amount is available to fill an order at the first near-TOB price.

22. The apparatus of claim 20, wherein the second indication of the second near-TOB price identifies a price at which more than 100% of the amount is available to fill an order at the second near-TOB price.

23. The apparatus of claim 22, wherein the second indication of the second near-TOB price takes into account at least price information including firm liquidity and last-look liquidity to generate a model of expected fill amount.

24. The apparatus of claim 19, wherein the particular asset is a unit of foreign exchange.
